(19) United States
(12) Patent Application Publication
(10) Pub. No.: US 2018/0056277 A1
(43) Pub. Date: Mar. 1, 2018

(54) NANOCATALYST WITH MESOPOROUS SHELL FOR HYDROGEN PEROXIDE PRODUCTION AND METHODFOR HYDROGEN PEROXIDE PRODUCTION USING THE SAME

(71) Applicants: Korea University Research and Business Foundation, Seoul (KR); Korea Institute of Science and Technology, Seoul (KR)

(72) Inventors: Kwan-Young Lee, Seoul (KR); Myung-gi Seo, Seoul (KR); Sang Soo Han, Seoul (KR); Ho Joong Kim, Seoul (KR); Deok-Yeon Jo, Gongju-si (KR); Young-Hoon Cho, Seoul (KR)

(73) Assignees: Korea University Research and Business Foundation, Seoul (KR); Korea Institute of Science and Technology, Seoul (KR)

(21) Appl. No.: 15/365,012

(22) Filed: Nov. 30, 2016

(30) Foreign Application Priority Data
Aug. 30, 2016 (KR) 10-2016-0110758

(51) Int. Cl. B01J 23/44; B01J 35/00; B01J 35/02; C01B 15/029

(52) U.S. Cl. CPC B01J 23/44; B01J 35/0013; C01B 15/029; B01J 35/023; B01J 35/0086

(57) ABSTRACT

Disclosed is a core-shell structured nanocatalyst for hydrogen peroxide production. The core-shell structured nanocatalyst includes a core composed of spherical silica immobilized with noble metal nanoparticles and a mesoporous shell surrounding the core. The use of the nanocatalyst with a mesoporous shell for the production of hydrogen peroxide from hydrogen and oxygen ensures high hydrogen conversion and hydrogen peroxide production rate compared to the use of conventional nanoparticle catalysts with a microporous shell. Also disclosed is a method for hydrogen peroxide production using the nanocatalyst.

### CROSS-REFERENCE TO RELATED APPLICATIONS

This application claims priority to Korea Patent Application No. 10-2016-0110758, filed Aug. 30, 2016, the disclosure of which is incorporated herein by reference.

### BACKGROUND OF THE INVENTION

### 1. Field of the Invention

The present invention relates to a nanocatalyst with a mesoporous shell for hydrogen peroxide production and a method for hydrogen peroxide production using the same. More specifically, the present invention relates to a core-shell structured nanocatalyst for hydrogen peroxide production consisting of a core composed of spherical silica immobilized with noble metal nanoparticles and a mesoporous shell surrounding the core, and a method for hydrogen peroxide production using the nanocatalyst.

### 2. Description of the Related Art

Hydrogen peroxide is used as a bleaching agent for pulp and fibers, a disinfectant or sterilizer, a semiconductor cleaning liquid, an oxidant for water treatment or an environmentally friendly oxidant in chemical reactions (e.g., in a reaction for propylene oxide synthesis). The global production of hydrogen peroxide was 2.2 million tons in 2009. Along with the recent increasing demand for propylene oxide, demand for hydrogen peroxide is expected to grow.

Hydrogen peroxide is currently produced by the sequential oxidation and hydrogenation of anthraquinones. This process requires the use of a large amount of an organic solvent and generates waste. The production of hydrogen peroxide involves multistep continuous processes and subsequent purification and concentration that require much energy.

Under these circumstances, processes for the synthesis of hydrogen peroxide by direct reaction of hydrogen with oxygen have received attention because they produce water as a by-product of the reaction and use a small amount of organic solvents. Due to these advantages, the direct production processes have been investigated as alternatives to current commercial processes. Due to their simplicity, the direct production processes can be carried out in situ where hydrogen peroxide is needed. This can considerably reduce the risk of explosion during storage and transport (Korean Patent Publication No. 2002-0032225).

Pd and Pd alloys (e.g., Pd—Au and Pd—Pt) are used as main catalysts for the direct production of hydrogen peroxide. During the direct production of hydrogen peroxide, a side reaction where hydrogen meets oxygen to create water and other water-producing side reactions. Since such side reactions are also spontaneous reactions, the use of catalysts is currently investigated to increase the selectivity for hydrogen peroxide. A great deal of research has been conducted on the addition of acids and halogen anions to solvents in order to increase the selectivity of palladium catalysts for hydrogen peroxide.

### SUMMARY OF THE INVENTION

The present inventors have earnestly conducted research to develop a method for hydrogen peroxide production, and as a result, have found that when a catalyst consisting of a core composed of spherical silica nanoparticles immobilized with palladium (Pd) nanoparticles and a mesoporous shell formed on the core is used for hydrogen peroxide production, the formation of the mesoporous shell facilitates the transfer of hydrogen as a reactant, leading to increased hydrogen conversion and hydrogen peroxide production rate. The present invention has been accomplished based on this finding.

Therefore, the present invention is intended to provide a catalyst for hydrogen peroxide production including a core composed of silica nanoparticles immobilized with noble metal nanoparticles and a mesoporous shell surrounding the core. The present invention is also intended to provide a method for preparing the catalyst.

The present invention is also intended to provide a method for hydrogen peroxide production using the catalyst, including feeding hydrogen and oxygen to a reactor where the hydrogen reacts with the oxygen in the presence of the catalyst in a solvent.

One aspect of the present invention provides a core-shell nanoparticle catalyst for hydrogen peroxide production including a core composed of silica nanoparticles immobilized with noble metal nanoparticles and a mesoporous shell surrounding the core.

A further aspect of the present invention provides a method for preparing a core-shell nanoparticle catalyst for hydrogen peroxide production, the method including (1) preparing nanoparticles of palladium (Pd) as a noble metal, (2) immobilizing the noble metal nanoparticles on silica nanoparticles, and (3) forming a mesoporous shell on the silica immobilized with the noble metal nanoparticles.

Another aspect of the present invention provides a method for hydrogen peroxide production using the core-shell nanoparticle catalyst, the method including feeding hydrogen and oxygen to a reactor where the hydrogen reacts with the oxygen in the presence of the catalyst in a solvent.

The use of the nanoparticle catalyst with a mesoporous shell according to the present invention for the production of hydrogen peroxide from hydrogen and oxygen ensures high hydrogen conversion and hydrogen peroxide production rate compared to the use of conventional nanoparticle catalysts with a microporous shell.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1a, 1b, 1c and 1d show transmission electron microscopy (TEM) images of (FIG. 1a) amine-modified silica (SiO₂) nanoparticles, (FIG. 1b) palladium (Pd) nanoparticles, and (FIG. 1c) and (FIG. 1d) amine-modified silica immobilized with Pd nanoparticles, all of which were prepared in Example 1;

FIGS. 2a, 2b, 2c, 2d, 2e and 2f show transmission electron microscopy (TEM) images of a nanoparticle catalyst m(2) (FIG. 2d) prepared in Example 1, nanoparticle catalysts m(1) (FIG. 2c), m(3) (FIG. 2e), and m(4) (FIG. 2f) prepared in Comparative Example 1, and nanoparticle catalysts s(1) (FIG. 2a) and s(2) (FIG. 2b) prepared in Comparative Example 2 (the thickness of a microporous shell increased in the order of s(1) (FIG. 2a) and s(2) (FIG. 2b) and the thickness of a mesoporous shell increased in the order of m(1) (FIG. 2c), m(2) (FIG. 2d), m(3) (FIG. 2e), and m(4) (FIG. 2f);

FIG. 3 shows mesopore size distributions of nanoparticle catalysts prepared in Example 1 and Comparative Examples 1 and 2, which were measured based on the results of nitrogen absorption-desorption experiments;

FIG. 4 shows hydrogen conversions and hydrogen peroxide selectivities when hydrogen peroxide was directly produced from hydrogen and oxygen in Example 2 and Comparative Examples 3 and 4; and

FIG. 5 shows hydrogen peroxide production rates when hydrogen peroxide was directly produced from hydrogen and oxygen in Example 2 and Comparative Examples 3 and 4.

### DETAILED DESCRIPTION OF THE INVENTION

The present invention will now be described in more detail.

The present invention is directed to a core-shell nanoparticle catalyst for hydrogen peroxide production including a core composed of silica nanoparticles immobilized with noble metal nanoparticles and a mesoporous shell surrounding the core.

The core-shell nanoparticle catalyst of the present invention is characterized by having a noble metal-immobilized silica core and a mesoporous shell. The nanoparticle catalyst of the present invention exhibits high hydrogen conversion and hydrogen peroxide production rate compared to a nanoparticle catalyst having a noble metal-immobilized silica core and a microporous shell.

The silica core may have an average size of 50 to 500 nm, preferably 100 to 300 nm. The noble metal nanoparticles may have an average size of 1 to 30 nm, preferably 2 to 20 nm. The noble metal may be gold (Au), palladium (Pd), platinum (Pt) or an alloy thereof.

The mesoporous shell may have an average thickness of 5 to 40 nm, preferably 5 to 15 nm.

The shell with a smaller average thickness than 5 nm fails to prevent the Pd nanoparticles from sintering during calcination of the catalyst. Meanwhile, the shell with a larger average thickness than 40 nm limits mass transfer, resulting in low hydrogen conversion and hydrogen peroxide yield. The catalyst can be used for the production of hydrogen peroxide by direct reaction of hydrogen with oxygen.

The present invention also provides a method for preparing a core-shell nanoparticle catalyst for hydrogen peroxide production, the method including (1) synthesizing spherical silica nanoparticles with surface amine groups, (2) synthesizing noble metal nanoparticles, (3) immobilizing the noble metal nanoparticles on the silica nanoparticles, and (4) synthesizing a mesoporous shell on the nanoparticles immobilized with the noble metal nanoparticles.

The present invention also provides a method for hydrogen peroxide production including feeding hydrogen and oxygen to a reactor where the hydrogen reacts with the oxygen in the presence of the core-shell nanoparticle catalyst in a solvent.

The solvent may be selected from the group consisting of methanol, ethanol, water, and mixtures thereof. Specifically, the solvent may be methanol, ethanol or a mixture thereof with water. Preferably, the solvent is a mixture of ethanol and water.

In the case where a palladium catalyst is used for direct hydrogen peroxide production, halogen anions are added to the solvent to increase the selectivity of the palladium catalyst for hydrogen peroxide. Thus, the solvent may include a halogen element. The halogen anion may be F⁻, Cl⁻, Br⁻ or I⁻. Br— is preferred. Br— may be present at a concentration of 0.1 to 0.9 mM, preferably 0.2 to 0.5 mM.

The solvent may further include an acid. The major role of the acid is to prevent the final product hydrogen peroxide from decomposition, leading to a marked increase in hydrogen peroxide yield. The acid may be, for example, sulfuric acid (H2SO4), hydrochloric acid (HCl), phosphoric acid (H₃PO₄) or nitric acid (HNO3). The acid is preferably phosphoric acid.

The concentration of the acid in the solvent may be from 0.01 to 1 M. Preferably, the acid concentration is from 0.01 to 0.05 M.

It would be desirable to directly feed the gaseous reactants hydrogen and oxygen to the solvent through dip tubes that can be dipped in the solvent. The use of the dip tubes improves the solubility of the reactants in the solvent. Preferably, the hydrogen and the oxygen are fed at flow rates of 1 to 4 mL/min and 10 to 40 mL/min, respectively. More preferably, the flow rates of the hydrogen and the oxygen are maintained at 1.5 to 2.5 mL/min and 15 to 25 mL/min, respectively, such that the molar ratio of the hydrogen to the oxygen is between 1:5 and 1:15. The oxygen reacts with the hydrogen in a molar ratio of 1:1 to produce hydrogen peroxide. If the molar ratio of the hydrogen to the oxygen is 1:≦5, there is a danger of explosion. Meanwhile, if the molar ratio of the hydrogen to the oxygen is 1:≧15, the low hydrogen concentration makes efficient hydrogen peroxide production difficult. It is thus preferred to limit the molar ratio of the hydrogen to the oxygen to the range defined above.

Preferably, nitrogen is further fed to the reactor for the reaction. The use of nitrogen can avert the risk of explosion even when the molar ratio of the hydrogen and the oxygen is adjusted to 1:1. Nitrogen does not need to be separated when oxygen in air is subsequently used as the reactant.

The total reaction pressure is regulated using a back pressure regulator (BPR) while allowing the hydrogen gas and the oxygen gas to flow at the predetermined rates. The reaction pressure can be measured using a manometer connected to the reactor. The reaction pressure is preferably maintained at 1 to 40 atm, preferably at ambient pressure. The reaction is preferably allowed to proceed while maintaining the reaction temperature at 10 to 30° C.

The use of the mesoporous nanoparticle catalyst according to the present invention for the production of hydrogen peroxide from hydrogen and oxygen ensures high hydrogen conversion and hydrogen peroxide production rate compared to the use of conventional microporous nanoparticle catalysts.

The present invention will be explained with reference to the following examples. However, these examples are provided to assist in a further understanding of the invention and the scope of the invention is not limited thereto.

### EXAMPLE 1

### Preparation of SiO₂@Pd@m-SiO₂ (m(2)) with Mesoporous Shell

### 1-1. Preparation of Palladium (Pd) Nanoparticles

0.212 g of polyvinylpyrrolidone (PVP), 0.12 g of L-ascorbic acid, 0.003 g of potassium bromide (KBr), and 0.097 g of potassium chloride (KCl) were dissolved in 16 mL of distilled water. After preheating at 80° C. for 30 min, the solution was added with 6 mL of a 64 mM disodium tetrachloropalladate (Na₂PdCl₄) solution and stirred at 80° C. for 3 h. After completion of the reaction, the reaction solution was mixed with acetone and centrifuged at 10000 rpm for 5 min. The resulting palladium (Pd) nanoparticles in the form of nanocubes were collected, washed with distilled water, and re-dispersed in 10 mL of distilled water.

### 1-2. Preparation of Amine-Modified Silica Nanoparticles (SiO)

74 mL of ethanol was mixed with 10 mL of distilled water and 3.15 mL of aqueous ammonia, and 6 mL of tetraethyl orthosilicate (Si(OC₂H₅)₄) as a silica precursor was added thereto. The mixture was stirred for 12 h to prepare nanoparticles.

The silica nanoparticles were washed with distilled water and propanol and dispersed in 320 mL of propanol. The dispersion was preheated to 80° C. and 3-aminopropyltriethoxysilane (ATPS) was added thereto to modify the silica nanoparticles with amine groups. After stirring at 80° C. for 2 h, the amine-modified silica nanoparticles were collected by centrifugation and dispersed in ethanol.

### 1-3. Immobilization of the Pd Nanoparticles on the Silica (SiO)

The silica (SiO₂) dispersion prepared in Example 1-2 was mixed with the dispersion of the Pd nanoparticles prepared in Example 1-1. After stirring for 2 h, silica (SiO₂)-supported Pd nanoparticles were collected by centrifugation and dispersed in 160 mL of ethanol.

1-4. Preparation of SiO₂@Pd@m-SiO₂ (m(2)) with Mesoporous Shell

1.1 g of hexadecyltrimethylammonium bromide (CTAB) was dissolved in the dispersion of the silica (SiO₂)-supported Pd nanoparticles prepared in Example 1-3, and 5.76 mL of distilled water and 2.5 mL of aqueous ammonia were added thereto. The mixture was added with 2.5 mL of TEOS as a silica precursor and stirred for 24 h to form a shell. Thereafter, the resulting nanoparticles were collected by centrifugation and calcined at 500° C. for 10 h to form mesopores. The synthesized catalyst was designated by m(2).

### Comparative Example 1

### Preparation of SiO₂@Pd@SiO₂ Nanoparticles with Mesoporous Shell

Catalysts were prepared in the same manner as in Example 1, except that the amount of TEOS added in 1-4 was changed to 1.2, 4.5, and 6.5 mL. The catalysts synthesized using 1.2, 4.5, and 6.5 mL of TEOS were designated by m(1), m(3), and m(4), respectively.

### Comparative Example 2

### Preparation of SiO₂@Pd@SiO₂ Nanoparticles with Microporous Shell

Catalysts were prepared in the same manner as in Example 1, except that CTAB was not added in 1-4 and the amount of TEOS added in 1-4 was changed to 1.2 and 2.5 mL. The catalysts synthesized using 1.2 and 2.5 mL of TEOS were designated by s(1) and s(2), respectively.

### Example 2

### Production of Hydrogen Peroxide Using the SiO₂@Pd@m-SiO₂ Nanoparticles (m(2)) with Mesoporous Shell

0.2 g of the silica-supported SiO₂@Pd@m-SiO₂ nanoparticles (m(2)) prepared in Example 1 were added to a mixture of distilled (120 mL), ethanol (30 mL), KBr (0.3 mM), and phosphoric acid (H₃PO₄) (0.03M) as a reaction solvent in a double-jacketed reactor. The reaction was allowed to proceed for 3 h. The reaction temperature and pressure were maintained at 20° C. and 1 atm, respectively. H₂ and O₂ (1/10) as reactant gases were allowed to flow at the same rate of 22 mL/min. Hydrogen peroxide as the reaction product was collected.

### Comparative Example 3

### Production of Hydrogen Peroxide Using the SiO₂@Pd@m-SiO₂ Nanoparticles (m(2)) with Mesoporous Shell

Hydrogen peroxide was produced in the same manner as in Example 2, except that the catalyst prepared in Comparative Example 1 was used instead of the catalyst prepared in Example 1.

### Comparative Example 4

### Production of Hydrogen Peroxide Using the SiO₂@Pd@SiO₂ Nanoparticles with Microporous Shell

Hydrogen peroxide was produced in the same manner as in Example 2, except that the catalyst prepared in Comparative Example 2 was used instead of the catalyst prepared in Example 1.

### Experimental Example 1

### Electron Microscopic Observation

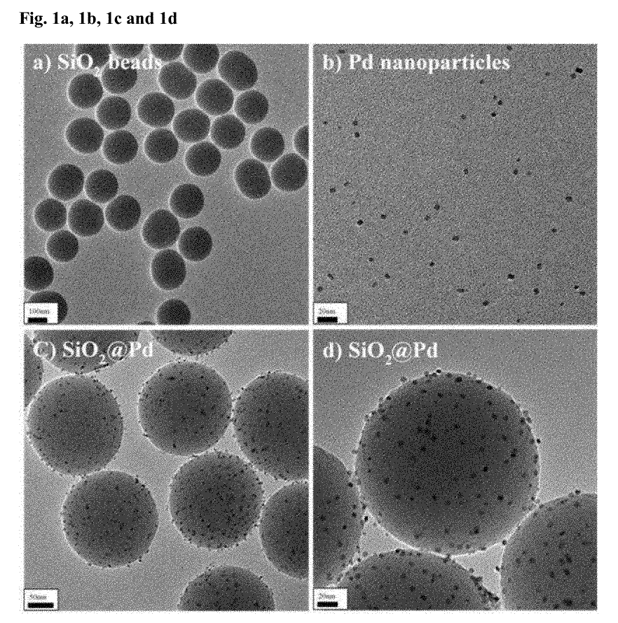

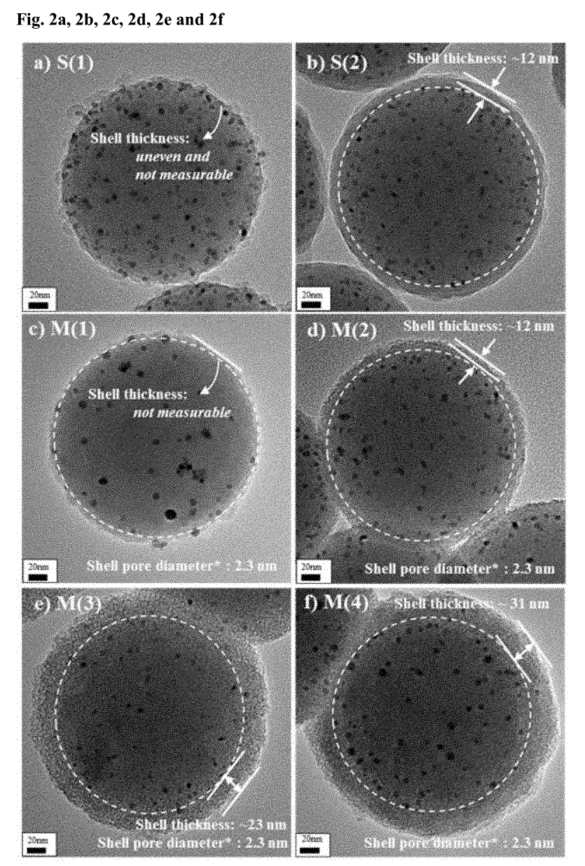

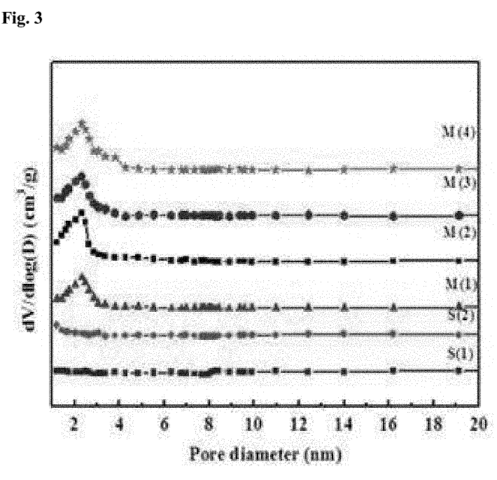

The catalysts prepared in Example 1 and Comparative Examples 1-2 were observed using an electron microscope. FIG. 1 shows transmission electron microscopy (TEM) images of the amine-modified silica (SiO₂) nanoparticles (a), the palladium (Pd) nanoparticles (b), and the amine-modified silica immobilized with the palladium nanoparticles (c) and (d), all of which were prepared in Example 1.

As shown in FIG. 1, the silica (SiO₂) nanoparticles had a diameter of ˜200 nm and were spherical in shape. The palladium (Pd) nanoparticles were in the form of cubes with a 4.5 nm size.

FIG. 2 shows TEM images of the catalyst m(2) prepared in Example 1, the catalysts m(1), m(3), and m(4) prepared in Comparative Example 1, and the catalysts s(1) and s(2) prepared in Comparative Example 2.

### Experimental Example 2

### Measurement of Palladium (Pd) Contents, Areas of Exposed Palladium, and Specific Surface Areas of the Catalysts by ICP-AES, CO-Chemisorption Analysis, and Nitrogen Adsorption-Desorption Experiments, Respectively

The palladium (Pd) contents of the catalysts prepared in Example 1 and Comparative Example 1 were measured by inductively coupled plasma atomic emission spectroscopy (ICP-AES). The surface areas of exposed palladium were measured by CO-chemisorption analysis. The specific surface areas of the catalysts were measured by nitrogen adsorption-desorption analysis. The results are shown in Table 1. The sizes of the shell pores were measured by the BJH method. The results are also shown in Table 1.

TABLE 1

| | | Palladium | Area of | Specific | Pore size |
|---|---|---|---|---|---|
| | | content | exposed Pd | surface area | of shell |
| | Catalyst | (wt %) | (m²/g_{-Pd}) | (m²/g_{-catal}) | (nm) |
| s(1) | Comparative Example 2 | 1.93 | 29.6 | 30.7 | — |
| s(2) | Comparative Example 2 | 1.63 | 37.0 | 93.4 | — |
| m(1) | Comparative Example 1 | 1.87 | 30.3 | 131.7 | 2.3 |
| m(2) | Example 1 | 1.50 | 43.0 | 221.6 | 2.3 |
| m(3) | Comparative Example 1 | 0.85 | 42.3 | 164.1 | 2.3 |
| m(4) | Comparative Example 1 | 0.81 | 43.0 | 192.1 | 2.3 |

As can be seen from the results in Table 1, the Pd content decreased with increasing amount of TEOS added. The areas of exposed Pd in the microporous catalysts s(1) and s(2) of Comparative Example 2 were smaller than those in the other catalysts. The mesoporous catalyst m(2) of Example 1 and the mesoporous catalysts of m(3) and m(4) of Comparative Example 1 had similar areas of exposed Pd. The area of exposed Pd in the catalyst m(1) of Comparative Example 1 was smaller because the shell did not prevent the Pd particles from sintering during calcination due to its very small thickness, which can be seen from the larger Pd particles in the TEM image.

### Experimental Example 3

### Hydrogen Peroxide Production

The concentrations of hydrogen peroxide collected in Example 2 and Comparative Examples 3 and 4 were determined by the iodine titration method and Equation 1:

$${H}_{2} {O}_{2} ( wt \% ) = \frac{17.0007 \times 0.01 \times {Na}_{2} {SO}_{2} ( μ L )}{weight of product ( g ) \times 1000} \times 100 \qquad ( 1 )$$

The productivities of hydrogen peroxide were calculated by Equation 2:

$$Productivity = \frac{{H}_{2} {O}_{2} synthesized}{weight of Pd \times reaction time} \qquad ( 2 )$$

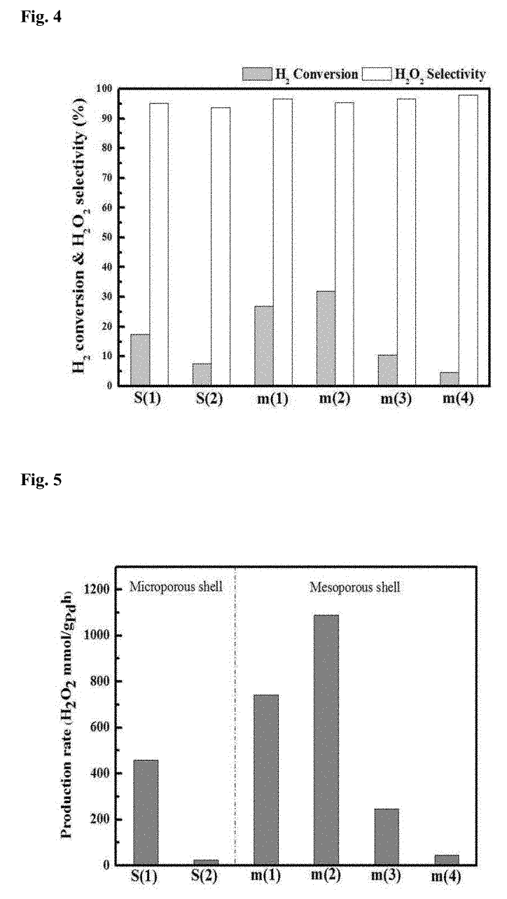

FIG. 4 shows hydrogen conversions and hydrogen peroxide selectivities when hydrogen peroxide was directly produced from hydrogen and oxygen in the presence of the catalysts. Hydrogen peroxide rates are shown in FIG. 5.

As shown in FIG. 4, the hydrogen conversion and hydrogen peroxide yield obtained when using the mesoporous nanoparticle catalyst m(2) were even higher than those obtained when using the microporous nanoparticle catalyst s(2). This is because the formation of mesopores facilitated the transfer of the reactants and the product. As the shell thickness increased (m(2)<m(3)<m(4)), the hydrogen conversion decreased, and as a result, the hydrogen peroxide yield decreased. The Pd nanoparticles were sintered in the catalyst m(1). This explains the lower hydrogen conversion when using the catalyst m(1) than when using the catalyst m(2).

As shown in FIG. 5, the hydrogen peroxide production rate increased significantly in response to increasing hydrogen conversion. From these results, it can be concluded that the use of the mesoporous nanoparticle catalyst m(2) in the direct reaction for the production of hydrogen peroxide brings about a significant increase in hydrogen conversion, resulting in a marked increase in hydrogen peroxide production rate.

What is claimed is:

1. A core-shell nanoparticle catalyst for hydrogen peroxide production comprising a silica nanoparticle core immobilized with noble metal nanoparticles and a mesoporous shell.

2. The core-shell nanoparticle catalyst according to claim 1, wherein the noble metal is selected from palladium (Pd), gold, (Au), platinum (Pt), and alloys thereof.

3. The core-shell nanoparticle catalyst according to claim 1, wherein the noble metal nanoparticles have a size of 1 to 30 nm.

4. The core-shell nanoparticle catalyst according to claim 1, wherein the core-shell nanoparticles are supported on silica (SiO₂), titania (TiO₂), alumina (Al₂O₃), zirconia (ZrO₂), carbon (C), and composites thereof.

5. The core-shell nanoparticle catalyst according to claim 1, wherein the mesoporous shell has a thickness of 5 to 40 nm.

6. A method for preparing a core-shell nanoparticle catalyst for hydrogen peroxide production, the method comprising (1) preparing noble metal nanoparticles, (2) immobilizing the noble metal nanoparticles on silica, and (3) coating a mesoporous shell on the silica immobilized with the noble metal nanoparticles.

7. A method for hydrogen peroxide production comprising feeding hydrogen and oxygen to a reactor where the hydrogen reacts with the oxygen in the presence of the core-shell nanoparticle catalyst according to claim 1 in a solvent.

8. The method according to claim 7, wherein the solvent is selected from the group consisting of methanol, ethanol, water, and mixtures thereof.

9. The method according to claim 7, wherein the solvent comprises halogen anions selected from the group consisting of fluorine, chlorine, bromine, and iodine anions.

10. The method according to claim 7, wherein the solvent further comprises at least one acid selected from the group consisting of sulfuric acid, hydrochloric acid, phosphoric acid, and nitric acid.

11. The method according to claim 7, wherein the molar ratio of the hydrogen to the oxygen is between 1:5 and 1:15.

12. The method according to claim 7, wherein the reaction is carried out at a pressure of 1 to 40 atm and a temperature of 10 to 30° C.
